(19) United States
(12) Patent Application Publication
(10) Pub. No.: US 2024/0034258 A1
(43) Pub. Date: Feb. 1, 2024

(54) BATTERY MODULE MOUNTING ASSEMBLY FOR A VEHICLE

(71) Applicants: HYUNDAI MOTOR COMPANY, Seoul (KR); KIA CORPORATION, Seoul (KR)

(72) Inventors: Myunghwan Kim, Hwaseong-si (KR); Jai Young An, Suwon-si (KR); Dong Seok Oh, Hwaseong-si (KR); Wan Je Cho, Hwaseong-si (KR); Gungoo Lee, Suwon-si (KR); Hyeonsu Jin, Bucheon-si (KR); Jun Young Kang, Goyang-si (KR); Eun Bi Kim, Seoul (KR); Sun Keun Park, Seoul (KR); Jae Yeon Kim, Hwaseong-si (KR); Seong-Bin Jeong, Hwaseong-si (KR)

(73) Assignees: HYUNDAI MOTOR COMPANY, Seoul (KR); KIA CORPORATION, Seoul (KR)

(21) Appl. No.: 18/203,867

(22) Filed: May 31, 2023

(30) Foreign Application Priority Data
Jul. 27, 2022 (KR) 10-2022-0093506

(51) Int. Cl. B60R 16/08; B60K 1/04; H01M 50/249; H01M 10/613; H01M 10/625; H01M 10/6567

(52) U.S. Cl. CPC B60R 16/08; B60K 1/04; H01M 50/249; H01M 10/613; H01M 10/625; H01M 10/6567; B60K 2001/0438

(57) ABSTRACT

A battery module mounting assembly for a vehicle includes a battery module disposed in a lower portion of a vehicle body, and a battery fixing frame respectively mounted on left and right sides of the battery module in a width direction of the vehicle. The battery fixing frame can fix the battery module to a lower portion of the vehicle body, and at least one hydraulic passage having both ends open in a front-rear direction of the vehicle is formed in an interior of the battery fixing frame.

### CROSS-REFERENCE TO RELATED APPLICATION

This application claims priority to and the benefit of Korean Patent Application No. 10-2022-0093506, filed in the Korean Intellectual Property Office on Jul. 27, 2022, the entire contents of which are incorporated herein by reference.

### BACKGROUND

### (a) Field of the Present Disclosure

The present disclosure relates to a battery module mounting assembly for a vehicle. More particularly, the present disclosure relates to a battery module mounting assembly for a vehicle, which is capable of integrally providing a hydraulic passage through which an operation fluid, such as a brake oil, a coolant, or a refrigerant, flows, as well as mounting the battery module on a lower portion of a vehicle body.

### (b) Description of the Related Art

In general, in a lower vehicle body of a vehicle, side members formed to extend along front and rear directions of the vehicle are disposed to both sides in the width direction of the vehicle body of the vehicle to reinforce structural strength of the vehicle body.

Meanwhile, in an electric vehicle, as a general term for vehicles moving by electric power including a hybrid electric vehicle, a high-capacity battery is mounted on a lower vehicle body (e.g., a floor panel) that forms the bottom surface of the vehicle body.

Here, in the lower portion of the vehicle body, the battery module is fixed to the floor panel and the side member through a mounting frame. In addition, driving devices are mounted on the front or rear of the electric vehicle corresponding to the front and rear wheels, respectively.

The electric vehicle is provided with a brake apparatus for braking front and rear wheels, an air-conditioner apparatus for adjusting the vehicle interior temperature, a cooling apparatus for cooling electrical components such as a driving apparatus and a battery, and the like.

However, the brake device, the air conditioning device, and the cooling device should have a plurality of pipes to circulate the respective operation fluids. however, since the vehicle body may only provide a limited space due to the size of the battery module and the mounting frame, it is difficult to avoid interference with the battery and to design paths of the fluids, and the layout of the pipes may become very complicated

In addition, the cost increases due to the application of separate brackets for fixing respective pipes to the vehicle body, and which are designed in a variety of designs depending on vehicle types, mounting positions, and the like. Therefore, working labor increases, and it is difficult to be automated.

The above information disclosed in this Background section is only for enhancement of understanding of the background of the present disclosure, and therefore it may contain information that does not form the prior art that is already known in this country to a person of ordinary skill in the art.

### SUMMARY

The present disclosure provides a battery module mounting assembly for a vehicle capable of preventing interference with other vehicle parts and streamlining layout of the pipes, by interiorly providing a hydraulic passage through an operation fluid, such as a brake oil, a coolant, or a refrigerant, flows, and by stably mounting a battery module on a lower portion of a vehicle body, and at the same time.

A battery module mounting assembly for a vehicle includes a battery module disposed in a lower portion of a vehicle body, and a battery fixing frame which is respectively mounted on left and right sides of the battery module in a width direction of the vehicle. The battery fixing frame fixes the battery module to a lower portion of the vehicle body. In particular, at least one hydraulic passage is formed in an interior of the battery fixing frame and has both ends that are open in a front-rear direction of the vehicle.

The at least one hydraulic passage may be configured to flow an operation fluid through the interior of the battery fixing frame.

The operation fluid may include one of a brake oil, a coolant, and a refrigerant.

A diameter of the at least one hydraulic passage may be determined based on a type of the operation fluid. In one embodiment, at least two hydraulic passages are formed with different diameters to flow different types of the operation fluid.

In another embodiment, multiple hydraulic passage may be respectively formed at positions, which are spaced apart by a preset interval along a height direction of the vehicle, of the battery fixing frame.

The battery fixing frame may be extruded such that the at least one hydraulic passage may be integrally formed.

In one embodiment, the battery fixing frame may include a main body interiorly forming the at least one hydraulic passage, a mounting portion protruding outward from the main body in the width direction of the vehicle to be connected to the vehicle body, and a supporting portion protruding inward from the main body in the width direction of the vehicle to support a lower portion of the battery module.

The supporting portion may be respectively formed at positions, which are spaced apart by a preset interval, of an interior lower portion of a main body facing the battery module.

A battery module mounting assembly may further include a connection connector that is respectively mounted on open both ends of the at least one hydraulic passage at a front end and a rear end of the battery fixing frame, with reference to the front-rear direction of the vehicle.

According to a battery module mounting assembly for a vehicle according to an embodiment, interference with other vehicle parts may be prevented, flow path layout of the operation fluid may be streamlined, and usage of pipes may be minimized, by interiorly providing a hydraulic passage through which an operation fluid such as a brake oil, a coolant, or a refrigerant, and the like flows and, as well as stably mounting a battery module on a lower portion of a vehicle body.

In addition, the present disclosure may be commonly applied to vehicles of the type using the same battery module, and since a pipe installation space is not required, an installation space of the battery module and the vehicle interior space may be sufficiently secured, thereby enabling application of a large capacity battery.

In addition, pipe fixing work may be removed, and thereby working labor may be reduced, while enhancing productivity.

### BRIEF DESCRIPTION OF THE DRAWINGS

FIG. 1 illustrates a battery module assembly for a vehicle according to an embodiment that is separated from a vehicle body.

FIG. 2 is an exploded perspective view of a battery module assembly for a vehicle according to an embodiment.

FIG. 3 is a partial enlarged perspective view of a battery fixing frame applied to a battery module assembly for a vehicle, according to an embodiment.

FIG. 4 is a cross-sectional view according to line A-A of FIG. 3.

FIG. 5 is a partial enlarged perspective view of a battery fixing frame applied to a battery module assembly for a vehicle, according to another embodiment.

FIG. 6 is a cross-sectional view according to line B-B of FIG. 5.

FIG. 7 is a partial enlarged perspective view of a battery fixing frame applied to a battery module assembly for a vehicle, according to a still another embodiment.

FIG. 8 is a cross-sectional view according to line C-C of FIG. 7.

### DETAILED DESCRIPTION

Embodiments of the present disclosure are hereinafter described in detail with reference to the accompanying drawings.

Prior to the detailed description, while this present disclosure is described in connection with what is presently considered to be practical embodiments, it is to be understood that the present disclosure is not limited to the disclosed embodiments, but on the contrary, is intended to cover various modifications and equivalent arrangements included within the spirit and scope of the present disclosure.

In order to clarify the present disclosure, parts that are not connected with the description have been omitted, and the same elements or equivalents are referred to by the same reference numerals throughout the specification.

The size and thickness of each element are arbitrarily shown in the drawings, and the present disclosure is not necessarily limited thereto, and in the drawings, the thickness of layers, films, panels, regions, etc., are exaggerated for clarity.

In addition, unless explicitly described to the contrary, the word “comprise”, and variations such as “comprises” or “comprising”, should be understood to imply the inclusion of stated elements but not the exclusion of any other elements.

Further, the terms “. . . unit”, “. . . mechanism”, “. . . portion”, “. . . member”, etc. used herein mean a unit of inclusive components performing one or more functions or operations. When a component, device, element, or the like of the present disclosure is described as having a purpose or performing an operation, function, or the like, the component, device, or element should be considered herein as being “configured to” meet that purpose or to perform that operation or function.

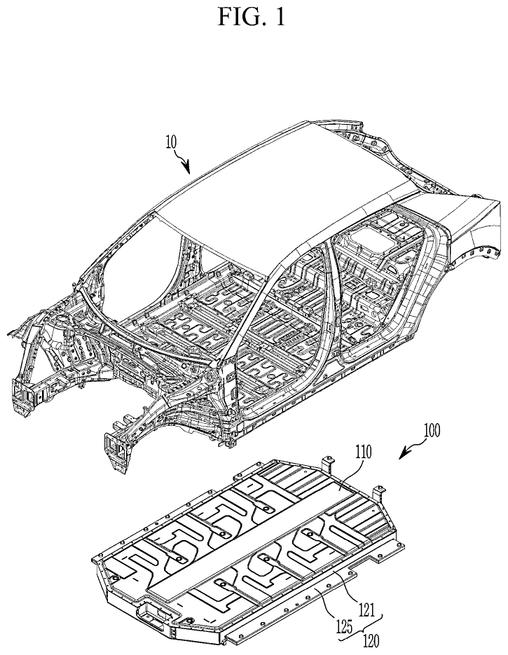

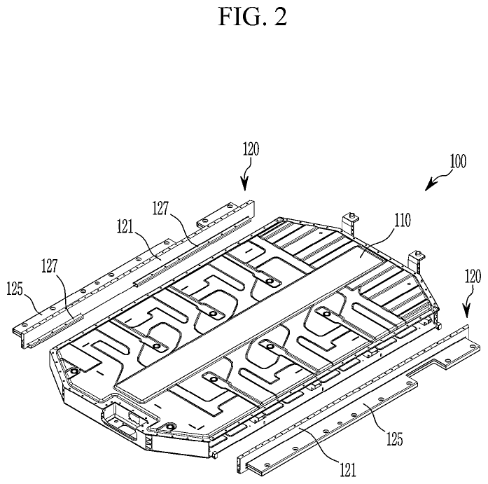

FIG. 1 illustrates a battery module assembly for a vehicle according to an embodiment that is separated from a vehicle body. FIG. 2 is an exploded perspective view of a battery module assembly for a vehicle according to an embodiment.

Referring to the drawings, a battery module mounting assembly for a vehicle according to an embodiment 100 is capable of preventing interference with other vehicle parts and streamlining layout of the pipes, by interiorly providing a hydraulic passage 123, through which an operation fluid such as a brake oil, a coolant, a refrigerant, and the like can flow. The battery module mounting assembly is also capable of stably mounting a battery module 110 on a lower portion of the vehicle body.

As shown in FIGS. 1-4, according to an embodiment of the present disclosure, a battery module mounting assembly 100 for a vehicle may include the battery module 110, and a battery fixing frame 120. In particular at least one hydraulic passage 123 is formed in the battery fixing frame 120.

First, the battery module 110 is configured to supply power to a driving apparatus and electrical components provided in the vehicle, and may be disposed in the lower portion of the vehicle body 10.

In one embodiment, the battery fixing frame 120 may be respectively mounted on a left and right sides of the battery module 110 in a width direction of the vehicle, and the battery fixing frame 120 may fix the battery module 110 to the lower portion of the vehicle body 10.

In addition, the at least one hydraulic passage 123 may be formed in an interior of the battery fixing frame 120, and both ends thereof may be open in a front-rear direction of the vehicle.

Here, the at least one hydraulic passage 123 may be configured to flow operation fluid through the interior of the battery fixing frame 120.

The operation fluid may be a brake oil circulated in a brake apparatus provided in the vehicle, a refrigerant circulated in an air-conditioner apparatus, or a coolant circulated in a cooling apparatus for cooling electrical components and the driving apparatus.

In one embodiment, with reference to a height direction of the vehicle, at least two hydraulic passages 123 may be formed at positions, which are spaced apart by a preset interval along a height direction of the vehicle, of the battery fixing frame 120 (e.g., a main body 121).

As shown in FIG. 2, in one embodiment, the battery fixing frame 120 may include the main body 121, a mounting portion 125, and a supporting portion 127.

First, the main body 121 may be formed as a hollow pipe in a rectangular shape. The hydraulic passages 123 may be formed in an interior of the main body 121.

The mounting portion 125 protrudes outward from the main body 121 in the width direction of the vehicle to be connected to the vehicle body 10.

The mounting portion 125 may be fixed to the lower portion of the vehicle body 10 by a fastening member such as a bolt.

In addition, in a state that the main body 121 is mounted on the battery module 110, the supporting portion 127 may protrude inward from the main body 121 in the width direction of the vehicle to support a lower portion of the battery module 110. In one embodiment, the supporting portion 127 may be formed at an interior lower portion of the main body 121 which faces the battery module 110.

In another embodiment, multiple supporting portions 127, which are spaced apart by a preset interval, may be formed at the interior lower portion of the main body 121, facing the battery module 110.

In one embodiment, two supporting portions 127 may be provided, at positions apart from each other in a length direction of the main body 121, and the two supporting portions 127 may have different lengths. For example, the two support portions 127 having different lengths are disposed at positions spaced apart in the longitudinal direction of the main body 121 .

Meanwhile, it is described in the present embodiment that the supporting portion 127 is provided as two items with different lengths, but it is not limited thereto. the quantity, lengths, and sizes of the supporting portion 127 may be varied depending on the size of the battery module 110, and/or a support position of the battery module 110.

Here, the battery fixing frame 120 may be extruded such that the at least one hydraulic passage 123 may be integrally formed in an interior.

Meanwhile, the battery module mounting assembly 100 may further include, with reference to the front-rear direction of the vehicle, a connection connector 130 respectively mounted on open both ends of the at least one hydraulic passage 123. The ends of the hydraulic passage 123 are disposed at a front end and a rear end of the battery fixing frame 120.

The connection connector(s) 130 may be provided in order to connect the hydraulic passage 123 to a separate connection pipe provided in the cooling apparatus, or the air-conditioner apparatus, or the brake apparatus through which the operation fluid circulates.

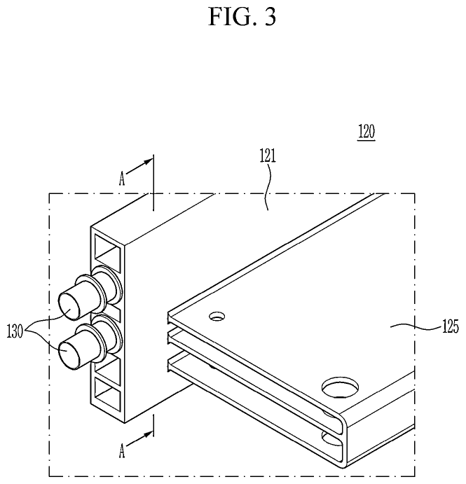

Various embodiments of the at least one hydraulic passage 123 in the battery module mounting assembly 100 according to an embodiment are described in further detail with reference to FIG. 3 to FIG. 8.

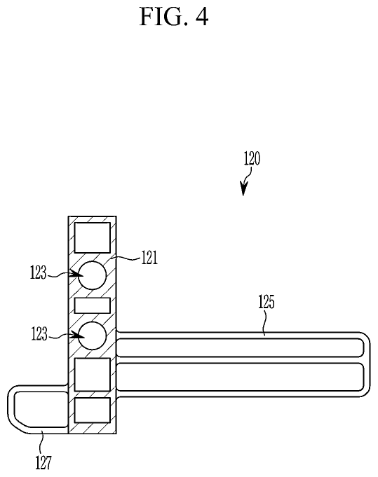

FIG. 3 is a partial enlarged perspective view of a battery fixing frame applied to a battery module assembly for a vehicle, according to an embodiment. FIG. 4 is a cross-sectional view according to line A-A of FIG. 3.

Referring to FIG. 3 and FIG. 4, the hydraulic passage 123 according to an embodiment may be formed in a plural quantity (e.g., two items), at positions apart from each other in a height direction of the main body 121.

The refrigerant circulated in the air-conditioner apparatus, or the coolant circulated in the cooling apparatus may be applied as the operation fluid flowing through the hydraulic passage 123.

In an embodiment, the hydraulic passage 123 is provided in a plural quantity (e.g., two items), such that the one operation fluid of the coolant or the refrigerant may be circulated.

In addition, the connection connectors 130 may be respectively mounted on a front end and a rear end of the hydraulic passages 123.

Accordingly, the applied operation fluid of chosen from the coolant and the refrigerant may flow from the front to the rear of the vehicle through a first hydraulic passage 123, and may flow from the rear to the front of the vehicle through a second hydraulic passage 123.

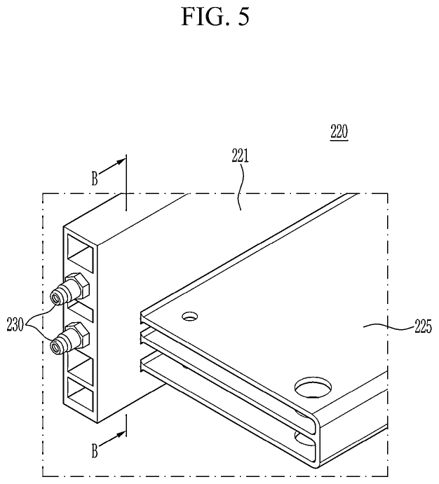

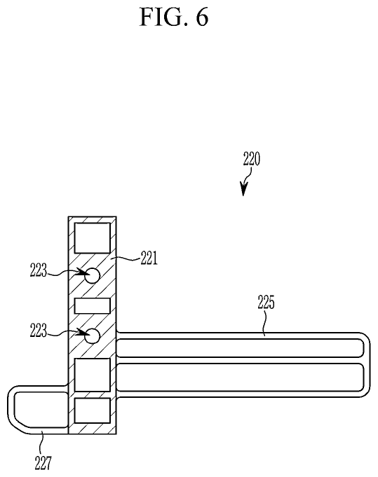

The battery fixing frame 220 according to another embodiment is described with reference to FIG. 5 and FIG. 6.

FIG. 5 is a partial enlarged perspective view of a battery fixing frame applied to a battery module assembly for a vehicle, according to another embodiment. FIG. 6 is a cross-sectional view according to line B-B of FIG. 5.

Referring to FIG. 5 and FIG. 6, with reference to a height direction of the main body 221, the at least one hydraulic passage 223 according to another embodiment may be formed in an upper portion and a center, respectively.

In addition, the connection connector 230 may be respectively mounted on a front end and a rear end of the hydraulic passages 223.

The brake oil circulated in the brake apparatus may be applied as the operation fluid flowing through the hydraulic passage 223.

Accordingly, the brake oil may flow from the front to the rear of the vehicle through a first hydraulic passage 223, and may flow from the rear to the front of the vehicle through a second hydraulic passage 223.

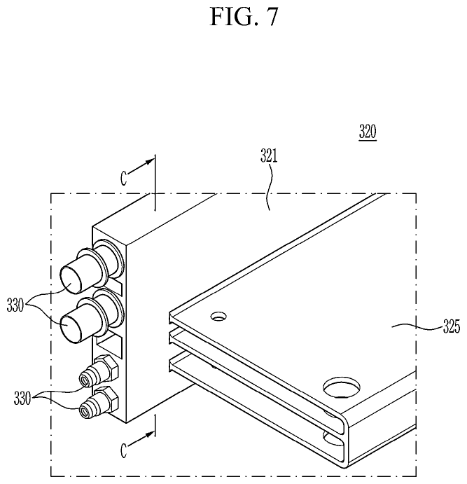

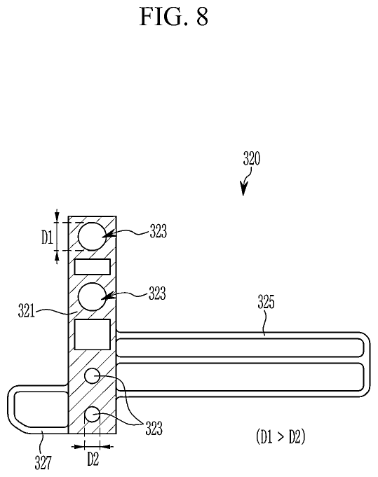

In addition, the battery fixing frame 320 according to a still another embodiment is described with reference to FIG. 7 and FIG. 8.

FIG. 7 is a partial enlarged perspective view of a battery fixing frame applied to a battery module assembly for a vehicle, according to a still another embodiment. FIG. 8 is a cross-sectional view according to line C-C of FIG. 7.

According to a still another embodiment, referring to FIG. 7 and FIG. 8, with reference to a height direction of the main body 321, the at least one hydraulic passage 323 may include a pair of hydraulic passages 323 in an upper portion and a lower portion respectively, so as to allow different operation fluids to flow therethrough.

In addition, the connection connectors 330 may be respectively mounted on each of a front end and a rear end of the hydraulic passages 323.

First, the refrigerant circulated in the air-conditioner apparatus, or the coolant circulated in the cooling apparatus may be applied as the operation fluid flowing through a pair of the hydraulic passage 323 formed in an upper portion of the main body 321.

Accordingly, in the upper portion of the main body 321, the applied operation fluid of chosen from the coolant and the refrigerant may flow from the front to the rear of the vehicle through the first hydraulic passage 223 provided in a pair, and may flow from the rear to the front of the vehicle through the first second hydraulic passage 123.

In addition, the brake oil circulated in the brake apparatus may be applied as the operation fluid flowing through the pair of the hydraulic passage 323 formed in a lower portion of the main body 321.

Accordingly, in the lower portion of the main body 321, the brake oil may flow from the front to the rear of the vehicle through a first hydraulic passage 323 provided in a pair, and may flow from the rear to the front of the vehicle through a second hydraulic passage 323.

That is, two different operation fluids may circulate through the hydraulic passage 323 formed in the main body 321.

Here, a diameter D1 of a pair of hydraulic passages 323 disposed in the upper portion of the main body 321 to flow the coolant or the refrigerant may be formed larger than a diameter D2 of another pair of hydraulic passages 323 disposed in the lower portion of the main body 321 to flow the brake oil.

That is, a diameter of the hydraulic passage 323 may be formed different depending on a type of the operation fluid flowing therethrough, and the diameter of the hydraulic passage 323 may be dependent on viscosity, flow rate, and pressure of the operation fluid.

According to a battery module mounting assembly 100 for a vehicle according to an embodiment, interference with other vehicle parts may be prevented, flow path layout of the operation fluid may be streamlined, and usage of pipes may be minimized, by interiorly providing a hydraulic passage 123, 223, and 323 through which the operation fluid such as a brake oil, a coolant, or a refrigerant, and the like flows and, as well as stably mounting a battery module 110 on a lower portion of a vehicle body.

In addition, the present disclosure may be commonly applied to vehicles of the type using the same battery module, and since a pipe installation space is not required, an installation space of the battery module and the vehicle interior space may be sufficiently secured, thereby enabling application of a large capacity battery.

In addition, pipe fixing work may be removed, and thereby working labor may be reduced, while enhancing productivity.

While this present disclosure has been described in connection with what is presently considered to be practical embodiments, it is to be understood that the present disclosure is not limited to the disclosed embodiments. On the contrary, it is intended to cover various modifications and equivalent arrangements included within the spirit and scope of the appended claims.

### DESCRIPTION OF SYMBOLS

10: the vehicle body
100: battery module mounting assembly
110: battery module
120, 220, 330: battery fixing frame
121, 221, 331: main body
123, 223, 333: hydraulic passage
125, 225, 335: mounting portion
127, 227, 327: supporting portion
130, 230, 330: connection connector

What is claimed is:

1. A battery module mounting assembly for a vehicle, comprising:
a battery module disposed in a lower portion of a vehicle body; and
a battery fixing frame respectively mounted on left and right sides of the battery module in a width direction of the vehicle, and configured to fix the battery module to the lower portion of the vehicle body,
wherein at least one hydraulic passage is formed in an interior of the battery fixing frame and includes first and second ends which are open in a front-rear direction of the vehicle.

2. The battery module mounting assembly of claim 1, wherein the at least one hydraulic passage is configured to flow an operation fluid through the interior of the battery fixing frame.

3. The battery module mounting assembly of claim 2, wherein the operation fluid comprises one of a brake oil, a coolant, and a refrigerant.

4. The battery module mounting assembly of claim 2, wherein a diameter of the at least one hydraulic passage is determined based on a type of the operation fluid.

5. The battery module mounting assembly of claim 1, wherein the at least one hydraulic passage includes a plurality of hydraulic passages, and
hydraulic passages of the plurality of hydraulic passages are respectively formed at positions, which are spaced apart by a preset interval along a height direction of the vehicle, of the battery fixing frame.

6. The battery module mounting assembly of claim 1, wherein the battery fixing frame is extruded such that the at least one hydraulic passage is integrally formed.

7. The battery module mounting assembly of claim 1, wherein the battery fixing frame comprises:
a main body interiorly forming the at least one hydraulic passage;
a mounting portion protruding outward from the main body in the width direction of the vehicle to be connected to the vehicle body; and
a supporting portion protruding inward from the main body in the width direction of the vehicle to support a lower portion of the battery module.

8. The battery module mounting assembly of claim 7, wherein the supporting portion is respectively formed at positions, which are spaced apart by a preset interval, of an interior lower portion of a main body, which is facing the battery module.

9. The battery module mounting assembly of claim 1, further comprising:
a connection connector that is respectively mounted on the first and second ends of the at least one hydraulic passage at a front end and a rear end of the battery fixing frame, with reference to the front-rear direction of the vehicle.
